(19) United States
(12) Patent Application Publication
(10) Pub. No.: US 2007/0027237 A1
(43) Pub. Date: Feb. 1, 2007

(54) Thickening additive

(76) Inventors: Hiromitsu Hamano, Nagano (JP); Yuji Uzuhashi, Nagano (JP); Hiroki Miyashita, Nagano (JP)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/189,968

(22) Filed: Jul. 26, 2005

(51) Int. Cl. C08K 5/52

(52) U.S. Cl. 524/141

(57) ABSTRACT

A thickening additive comprises a xanthan gum. A paste including one or more of sodium alginate, pectin and sodium CMC is added to the xanthan gum.

### BACKGROUND OF THE INVENTION

The present invention relates to a thickening additive capable of producing a fluid aqueous solution with low viscosity. The thickening additive is adjusted such that addition of the thickening additive to a water-containing object thickens the object more than before the addition or expresses gelation. In particular, it relates to a thickening additive suitable for food uses in thickening gravies, dressings, sauces, mousses, and jerry easily and for uses in expressing viscosity or gelation by addition of the thickening additive to meals for patients who suffer from chewing/swallowing difficulties due to intake disorders.

A number of pastes have been employed as thickening stabilizers in foods and so forth in the art. The pastes are commercially available commonly as dried goods in the forms of powders, plates and threads, which are solved in cold water or hot water for use. A paste has a high viscosity and accordingly requires much time and labor for solution. A mass may arise depending on the paste and insufficient heating may cause a solution failure. To the contrary, thermal decomposition may occur in some cases. Therefore, it is not always easy for general consumers to use the paste as a thickening stabilizer in foods.

The inventor et al. have proposed a thickening additive solution in JP-A 12-41594, which comprises a paste such as xanthan gum, and a low-viscosity polysaccharide such as gum arabic, alabinogalactan, pullulan and bean polysaccharide added thereto. This thickening additive solution is fluid but adjusted to express viscosity or gelation when it is added to a water-containing object. Accordingly, the thickening additive solution can be easily dispersed in water-containing objects. In addition, it can provide the object with viscosity or gelate the object easily. Therefore, even general consumers can use the thickening additive solution easily.

In the thickening additive solution described in JP-A 12-41594, however, the low-viscosity polysaccharide aimed at lowering viscosity, such as gum arabic, alabinogalactan, pullulan and bean polysaccharide, has respective unique odor and taste. The unique odor and taste may exert influences on the finished products. In addition, the solution may easily be made uneven due to variations with time as a problem.

The present invention has an object to provide a thickening additive with stability over time, which can be employed easily without having unique odor and taste that exert influences on the final products.

### SUMMARY OF THE INVENTION

To achieve the above object, the present invention provides a thickening additive, which comprises a xanthan gum; and a paste including one or more of sodium alginate, pectin and sodium CMC (sodium carboxymethyl cellulose) and added to the xanthan gum.

When the thickening additive according to the present invention is solved in water, the paste including one or more of sodium alginate, pectin and sodium CMC suppress thickening of the xanthan gum or expression of gelation, resulting in a fluid and easy-treatable solution. Different from gum arabic, alabinogalactan, pullulan and bean polysaccharide, these pastes have no unique odor and taste, which therefore exert influences on the final products.

### BRIEF DESCRIPTION OF THE DRAWINGS

FIG. 1 is a graph showing variations in viscosity in accordance with the amounts of sodium alginate added to xanthan gum; and

FIG. 2 is a graph showing variations in viscosity in accordance with the amounts of sodium CMC added to xanthan gum.

### DETAILED DESCRIPTION OF THE INVENTION

The thickening additive according to the present invention may be prepared in the form of a solid such as a powder or in the form of a liquid such as an aqueous solution. When it is a powder, for example, it is not aggregated easier characteristically than when only xanthan gum is dispersed and dissolved in water. The thickening additive according to the present invention may be processed, for example, mixed with an excipient such as dextrin or formed in particles, such that it can be easily dissolved in water to form a fluid liquid.

In the thickening additive according to the present invention, preferably, the paste includes one or more of sodium alginate with an average molecular weight of 5000-1000000, pectin with an average molecular weight of 5000-1000000, and sodium CMC with an average molecular weight of 5000-1200000. The average molecular weights of sodium alginate, pectin and sodium CMC can be adjusted through acidic or thermal hydrolysis of sodium alginate, pectin and sodium CMC.

In the thickening additive according to the present invention, preferably, a ratio of xanthan gum to sodium alginate is 1:0.2-10, and a ratio of xanthan gum to sodium alginate with the average molecular weight of 5000-1000000 is 1:0.1-20. Preferably, a ratio of xanthan gum to pectin is 1:0.2-10, and a ratio of xanthan gum to pectin with the average molecular weight of 5000-1000000 is 1:0.1-20. Preferably, a ratio of xanthan gum to sodium CMC is 1:0.2-10, and a ratio of xanthan gum to sodium CMC with the average molecular weight of 5000-1200000 is 1:0.1-20.

In the thickening additive according to the present invention, preferably, the xanthan gum and the paste are solved in the form of a liquid having a viscosity adjusted lower than that of only xanthan gum. If the viscosity is adjusted lower than that of only xanthan gum in this way, the fluidity is increased to allow the thickening additive to easily disperse in an object. Therefore, the thickening additive can be treated easily and employed simply by even general consumers.

Preferably, the thickening additive according to the present invention is adjusted such that addition of the thickening additive to a water-containing object thickens the object more than before the addition or expresses gelation. When thickening or expression of gelation is suppressed in this way, desired viscosity or gelled products can be obtained easily in a short time.

When thickening or expression of gelation is suppressed after dissolved in water, the content in the aqueous solution of xanthan gum and sodium alginate in combination is 1-30%, preferably 2-15%, and the content in the aqueous solution of xanthan gum and sodium alginate with the average molecular weight of 5000-1000000 in combination is 1-40%, preferably 2-20%. The content in the aqueous solution of xanthan gum and pectin is 1-30%, preferably 2-15%, and the content in the aqueous solution of xanthan gum and pectin with the average molecular weight of 5000-1000000 is 1-40%, preferably2-20%. The content in the aqueous solution of xanthan gum and sodium CMC is 1-30%, preferably 2-15%, and the content in the aqueous solution of xanthan gum and sodium CMC with the average molecular weight of 5000-1200000 is 1-40%, preferably 2-20%.

The uses of such the thickening additive include the use in the base of a seasoning solution for foods that require stickiness (such as Happosai, or a Chinese dish containing eight kinds of ingredients, and Mabodofu, or bean-curd soup seasoned with red pepper). Preferably, such the seasoning solution has lower viscosity and higher fluidity when it is mixed or it is filled into small portioned-packages. To the contrary, preferably, it is thinned with water extracted from vegetables and so forth during cocking to express viscosity. Therefore, a thickening additive such as that of the present invention is effective. The uses of such the thickening additive also include the use in the base for addition of viscosity to foods that are desired to have viscosity suitable for patients who suffer from chewing/swallowing difficulties due to intaked is orders. Other than foods, the thickening additive may be employed in wider uses, such as the use for cosmetics and medicines, the daily use for sundries, and the industrial use.

Examples of the thickening additive according to the present invention will now be described.

### EXPERIMENTAL EXAMPLE 1

First, to obtain thickening additives according to examples 1-6 as shown in Table 1, a xanthan gum (available from CP Kelco) is mixed at a ratio of 1:1 with: a sodium alginate with an average molecular weight of 1500000 (available from Dainihon Pharmacy Co., Ltd.); a low molecular sodium alginate with an average molecular weight of 50000 (available from Kimika Corp.); a sodium CMC with an average molecular weight of 3000000 (available from Daiichi Industrial Pharmacy Co., Ltd.); a low molecular sodium CMC with an average molecular weight of 80000 (available from Daiichi Industrial Pharmacy Co., Ltd.); a LM pectin with an average molecular weight of 487000 (available from CP Kelco); and a low molecular LM pectin with an average molecular weight of 370000, which is based on an aqueous solution of 5% LM pectin with the average molecular weight of 487000, adjusted to pH 3.0 with addition of a citric acid, then heated at 90 ° C. for 10 hours, neutralized with sodium hydroxide, and precipitated in alcohol.

TABLE 1

| | |
|---|---|
| Example 1 | Sodium Alginate |
| Example 2 | Low Molecular Sodium Alginate |
| Example 3 | Sodium CMC |
| Example 4 | Low Molecular Sodium CMC |
| Example 5 | LM Pectin |
| Example 6 | Low Molecular LM Pectin |
| Comparative Example 1 | None |
| Comparative Example 2 | Low Molecular Locust Bean Gum |
| Comparative Example 3 | Low Molecular Tara Gum |
| Comparative Example 4 | Low Molecular Guar Gum |
| Comparative Example 5 | Low Molecular Glucomannan |
| Comparative Example 6 | Low Molecular Tamarind Gum |

As a comparative example 1, the above xanthan gum (available from CP Kelco) is prepared. To obtain thickening additives according to comparative examples 2-6, the xanthan gum is mixed at a ratio of 1:1 with: a low molecular locust bean gum with an average molecular weight of 1500000, which is based on an aqueous solution of 3% locust bean gum with an average molecular weight of 4000000 (available from CP Kelco), adjusted to pH 3.0 with addition of a citric acid, then heated at 90 ° C. for 5 hours, neutralized with sodium hydroxide, and precipitated in alcohol; a low molecular tara gum with an average molecular weight of 780000, which is based on an aqueous solution of 2% tara gum with an average molecular weight of 6930000 (available from Ina Foods Industry Co., Ltd.), adjusted to pH 3.0 with addition of a citric acid, then heated at 90 ° C. for 9 hours, neutralized with sodium hydroxide, and precipitated in alcohol; a low molecular guar gum with an average molecular weight of 3500, which is based on an aqueous solution of 2% guar gum with an average molecular weight of 11500000 (available from IGI Inc.), adjusted to pH 3.0 with addition of a citric acid, then heated at 90 ° C. for 13 hours, neutralized with sodium hydroxide, and precipitated in alcohol; a low molecular glucomannan with an average molecular weight of 980000, which is based on an aqueous solution of 2% glucomannan with an average molecular weight of 3740000 (available from Ina Foods Industry Co., Ltd.), adjusted to pH 3.0 with addition of a citric acid, then heated at 90 ° C. for 20 hours, neutralized with sodium hydroxide, and precipitated in alcohol; and a low molecular tamarind gum with an average molecular weight of 180000, which is based on an aqueous solution of 4% tamarind gum with an average molecular weight of 3360000 (available from Dainihon Pharmacy Co. ,Ltd.), adjusted to pH 3.0 with addition of a citric acid, then heated at 90 ° C. for 15 hours, neutralized with sodium hydroxide, and precipitated in alcohol.

Next, aqueous solutions of 6% thickening additives according to the examples 1-6 and comparative examples 2-6 and an aqueous solution of 3% xanthan gum according to the comparative example 1 are prepared to measure respective viscosity at 25 ° C. using a B-type rotary viscometer (Vismetron, rotation speed of 60 rpm, available from Shibaura System Co., Ltd.). The results are shown in Table 2.

TABLE 2

| | Viscosity (mPa · s) |
|---|---|
| Example 1 | 38820 |
| Example 2 | 7620 |
| Example 3 | 39700 |
| Example 4 | 1000 |
| Example 5 | 34000 |
| Example 6 | 12300 |
| Comparative Example 1 | 44200 |
| Comparative Example 2 | 97000 |
| Comparative Example 3 | 100000 or higher |
| Comparative Example 4 | 100000 or higher |
| Comparative Example 5 | 100000 or higher |
| Comparative Example 6 | 74000 |

As shown in Table 2, the thickening additives according to the comparative examples 2-6 are thickened more than the xanthan gum according to the comparative example 1. To the contrary, the thickening additives according to the examples 1-6 have lower viscosity than that of the xanthan gum according to the comparative example 1. Accordingly, it is obvious that thickening or expression of gelation can be suppressed. In particular, the thickening additives according to the examples 2, 4 and 6 containing the low molecular paste mixed therein have extremely lower viscosity than that of the xanthan gum according to the comparative example 1.

### EXPERIMENTAL EXAMPLE 2

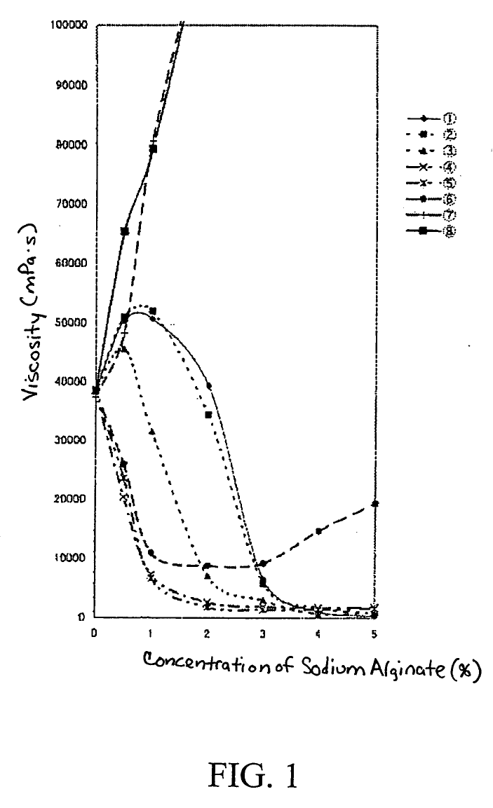

A sodium alginate with an average molecular weight of 2400000 (available from Dainihon Pharmacy Co., Ltd.) is hydrolyzed to obtain sodium alginates 1-8 with average molecular weights shown in Table 3. Then, an aqueous solution of 3% xanthan gum (available from CP Kelco) is mixed with the sodium alginates 1-8 at a different mixing ratio to measure respective viscosity at 25° C. using a B-type rotary viscometer (Vismetron, rotation speed of 60 rpm, available from Shibaura System Co., Ltd.). The results are shown in FIG. 1. As obvious from FIG. 1, addition of a certain amount or more of the sodium alginate with a smaller average molecular weight lowers viscosity.

TABLE 3

| | Average Molecular Weight |
|---|---|
| Sodium Alginate 1 | 46000 |
| Sodium Alginate 2 | 83000 |
| Sodium Alginate 3 | 130000 |
| Sodium Alginate 4 | 210000 |
| Sodium Alginate 5 | 270000 |
| Sodium Alginate 6 | 570000 |
| Sodium Alginate 7 | 1430000 |
| Sodium Alginate 8 | 2270000 |

### EXPERIMENTAL EXAMPLE 3

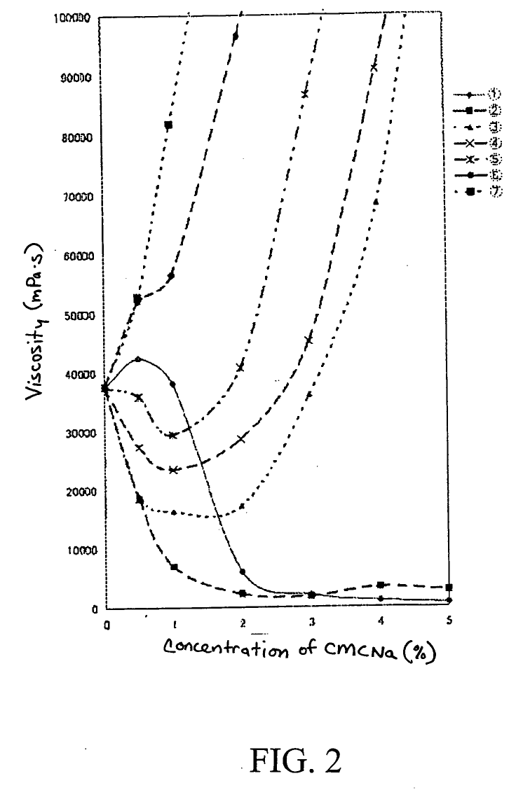

A sodium CMC with an average molecular weight of 3200000 (available from Daiichi Industrial Pharmacy Co., Ltd.) is hydrolyzed to obtain sodium CMCs 1-7 with average molecular weights shown in Table 4. Then, an aqueous solution of 3% xanthan gum (available from CP Kelco) is mixed with the sodium CMCs 1-7 at a different mixing ratio to measure respective viscosity at 25° C. using aB-type rotary viscometer (Vismetron, rotation speed of60 rpm, available from Shibaura System Co., Ltd.). The results are shown in FIG. 2. As obvious from FIG. 2, addition of a certain amount or more of the sodium CMC with a smaller average molecular weight lowers viscosity.

TABLE 4

| | Average Molecular Weight |
|---|---|
| Sodium CMC 1 | 80000 |
| Sodium CMC 2 | 180000 |
| Sodium CMC 3 | 420000 |
| Sodium CMC 4 | 710000 |
| Sodium CMC 5 | 1230000 |
| Sodium CMC 6 | 2170000 |
| Sodium CMC 7 | 3240000 |

### EXPERIMENTAL EXAMPLE 4

Next, a xanthan gum (available from CP Kelco) is mixed with the sodium alginate 3 of the experimental example 2 in water at a formula shown in Table 5 to obtain the thickening additive according to the example 7. In addition, a xanthan gum (available from CP Kelco) is mixed in water at a formula shown in Table 5 to obtain the aqueous solution of xanthan gum according to the comparative example 7.

TABLE 5

| | Example 7 | Comparative Example 7 |
|---|---|---|
| Xanthan Gum | 6 | 6 |
| Low Molecular Sodium Alginate 3 | 3 | 0 |
| Water | 91 | 94 |

(wt. %)

The aqueous solution of xanthan gum according to the comparative example 7 has high viscosity with no fluidity at all. To the contrary, the thickening additive according to the example 7 has low viscosity with fluidity. A solution of tea is extracted from tealeaf served 1.5 times denser than normal, to which the thickening additive according to the example 7 is added by 8% and dispersed therein. As a result, viscosity can express immediately at the same time of agitation, giving appropriate stickiness, allowing even patients who suffer from the swallowing difficulty to intake it easily.

### EXPERIMENTAL EXAMPLE 5

Next, a xanthan gum (available from CP Kelco) is mixed with the sodium alginate 3 of the experimental example 2, granulated sugar, cocoa powder, spices and brandy at a formula shown in Table 6 and dissolved in water to obtain cocoa mousse according to the example 8. When 25 g of this cocoa mousse is mixed in 300 cc of milk and agitated, viscosity immediately expresses, resulting in smooth cocoa mousse.

TABLE 6

| | |
|---|---|
| Xanthan Gum | 5 parts |
| Sodium Alginate 3 | 2 parts |
| Granulated Sugar | 40 parts |
| Cocoa Powder | 12 parts |
| Spices | Proper Quantity |
| Brandy | Proper Quantity |
| Water | 40 parts |

### EXPERIMENTAL EXAMPLE 6

Next, a xanthan gum (available from CP Kelco) is mixed with the sodium CMC 1 of the experimental example 3 in water at a formula shown in Table 7 to make a solution A. In addition, a solution B is made at a formula shown in Table 8. These solutions A and B are mixed to obtain a mixed seasoning of Tenmensho according to the example 9. The mixed seasoning of Tenmensho according to the example 9 is fluid and can be filled into small portioned-packages.

TABLE 7

| | | |
|---|---|---|
| Xanthan Gum | 2 | parts |
| Sodium CMC 1 | 0.5 | part |
| Water | 10 | parts |

TABLE 8

| | |
|---|---|
| Soy Sauce | 25 parts |
| Sake | 10 parts |
| Sugar | 10 parts |
| Tenmensho | 20 parts |
| Powdery Consommé | 1 part |

Next, sliced pork, eggplant, leek, ginger, garlic and red pepper are fried in oil, then 150 cc of hot water and 30 cc of the mixed seasoning of Tenmensho according to the example 9 are added. As a result, the mixed seasoning of Tenmensho expresses viscosity and gives appropriate stickiness, making a viscose seasoning without solving starch in water.

As obvious from the foregoing, in the thickening additive according to the present invention, the xanthan gum is employed together with the paste including one or more of sodium alginate, pectin and sodium CMC. Thus, the present invention is possible to provide a thickening additive with stability over time, which can be employed easily without having unique odor and after-taste that exert influences on the final products.

What is claimed is:

1. A thickening additive, comprising:
a xanthan gum; and
a paste including one or more of sodium alginate, pectin and sodium CMC and added to said xanthan gum.

2. The thickening additive according to claim 1, wherein said paste includes one or more of sodium alginate with an average molecular weight of 5000-1000000, pectin with an average molecular weight of 5000-1000000, and sodium CMC with an average molecular weight of 5000-1200000.

3. The thickening additive according to claim 1, wherein said xanthan gum and said paste are solved in the form of a liquid having a viscosity adjusted lower than that of only xanthan gum.

4. The thickening additive according to claim 3, wherein said thickening additive is adjusted such that addition of said thickening additive to a water-containing object thickens said object more than before said addition or expresses gelation.

5. The thickening additive according to claim 2, wherein said xanthan gum and said paste are solved in the form of a liquid having a viscosity adjusted lower than that of only xanthan gum.

6. The thickening additive according to claim 5, wherein said thickening additive is adjusted such that addition of said thickening additive to a water-containing object thickens said object more than before said addition or expresses gelation.
